(19) United States
(12) Patent Application Publication
(10) Pub. No.: US 2008/0236374 A1
(43) Pub. Date: Oct. 2, 2008

(54) Instrument having capacitance sense inputs in lieu of string inputs

(75) Inventors: Marcus Kramer, San Diego, CA (US); Michael T. Moore, Milpitas, CA (US)

Correspondence Address: Haverstock & Owens- Cypress, 162 North Wolfe Road, Sunnyvale, CA, 94086, US

(73) Assignee: Cypress Semiconductor Corporation

(21) Appl. No.: 11/731,449

(22) Filed: Mar. 30, 2007

(51) Int. Cl. G10H 3/10

(52) U.S. Cl. 84/733

(57) ABSTRACT

An electronic system can generate music related data based on capacitive sensed inputs. The system can include a plurality of capacitance sensor inputs for receiving connection to a plurality of capacitance sensors. At least one activation input can be included for receiving at least one activation signal generated in response to a physical action on the system. A control section can be coupled to the capacitive sensor inputs and the at least one activation input, the control section including at least one processor for sensing the capacitance at each capacitive sense input and generating sense position information therefrom.

### TECHNICAL FIELD

The present invention relates generally to musical instruments, and more particularly to musical instruments that include strings for generating sound and/or emulating musical instruments having strings for generating sound.

### BACKGROUND OF THE INVENTION

Stringed musical instruments can take a variety of shapes, but typically include a neck portion on which strings can be disposed, as well as a body, or sounding portion, to which the strings can be attached. Pitch variation is accomplished by varying the frequency at which a string vibrates by physically forcing one end of the string to the neck (e.g., fret, in a guitar). Electric stringed instruments typically include some sort of pick-up device for detecting the vibration of the strings, and transforming such vibrations into one or more electrical signals.

A drawback to traditional stringed musical instruments can be the difficulty encountered by beginners in the learning process. Holding down strings onto a neck portion can be painful. Along these same lines, holding down multiple strings can take considerable finger strength, and may not be possible for people with weaker finger strength.

Stringed instruments can also require frequent tensioning to ensure that the instrument remains in tune. Thus, most stringed instruments, include a tensioning apparatus (e.g., tuners) at one or both ends of a neck portion (e.g., a headstock).

Electronic instruments are known that mimic a guitar shape, but replace a stringed fret region of a neck with various mechanical switches and inputs. For example, devices are known that include a piano-type keyboard arrangement (i.e., black and white keys) in a fret neck area, or other types of switches.

A drawback to such string replacement approaches can be the limited number of buttons/inputs such devices provide. Further, such instruments can often fail to realistically recreate actual stringed instrument play, or may provide unrealistic sounds or responses as compared to an actual stringed instrument.

### BRIEF DESCRIPTION OF THE DRAWINGS

FIG. 1 is top view of an instrument according to a first embodiment.

FIGS. 2A to 2D are top plan views showing examples of a playing surface according to various embodiments.

FIG. 3 is a diagram showing a sense operation according to a stringless embodiment.

FIG. 4 is a diagram showing a sense operation according to a stringed embodiment.

FIGS. 5A and 5B are side cross sectional views showing capacitance sensors according to two embodiments.

FIG. 6A is a diagram of a capacitance sensor that can be included in the embodiments. FIGS. 6B to 6D are diagrams showing wiring arrangements for capacitance sensors according to various embodiments.

FIG. 7 is a block schematic diagram of a capacitance sensing system that can be included in the embodiments.

FIG. 8 is a block schematic diagram of another capacitance sensing system that can be included in the embodiments.

FIG. 9 is a flow diagram of a capacitance sense method that can be executed by a capacitance sense system like that shown in FIGS. 7 and/or 8.

FIG. 10 is a block schematic diagram of a capacitance sensor array that can be included in the embodiments.

FIG. 11A is a block schematic diagram of a system according to an embodiment.

FIG. 11B shows an input indication approach according to an embodiment.

FIG. 12 shows one approach to reprogramming capacitance sensor grouping.

FIGS. 13A to 13B show examples of how one particular capacitance sensor array can be reprogrammed into different group configurations.

FIGS. 14A and 14B show the generation of a sound value according to embodiments.

FIG. 15 shows the generation of a sound activation value from a capacitance sensor array according to an embodiment.

FIG. 16 shows the location of capacitance sensors on a neck portion according to an alternate embodiment.

FIGS. 17A and 17B show embodiments in which visual indicators can be included with a capacitance sensor array.

FIG. 18 shows an instrument according to an alternate embodiment.

FIG. 19 shows an instrument according to another alternate embodiment.

FIG. 20 shows one example of an instrument having an articulating neck portion, according to an embodiment.

FIG. 21 shows an instrument according to an alternate embodiment.

FIG. 22 shows an instrument according to an alternate embodiment.

FIG. 23 shows an embodiment that includes a neck portion compatible with existing body portions and/or removeable from a body portion.

FIGS. 24 and 25 shows neck portions having tactile indicators on a playing surface.

FIGS. 26 to 29B show various examples of body input sections that can be included in the embodiments.

FIGS. 30 to 33 are schematic diagrams of body input sections that can be included in the embodiments.

FIG. 34 shows an encoding circuit according to one embodiment.

FIG. 35 shows a sound generation circuit according to an embodiment.

FIG. 36 shows how sound activation values from both a capacitance sensor array in a neck portion and those from a body input section can be logically combined into a single sound activation value.

FIG. 37 is a block schematic diagram of a controller according to one embodiment.

FIGS. 38 to 42 are block schematic diagrams showing various system embodiments.

### DETAILED DESCRIPTION

Various embodiments of the present invention will now be described in detail with reference to a number of drawings. The embodiments show instruments, instrument systems, and processing methods that can be used in the generation of music data that can utilize capacitive sensing in a lieu of sensing a sound signal from strings.

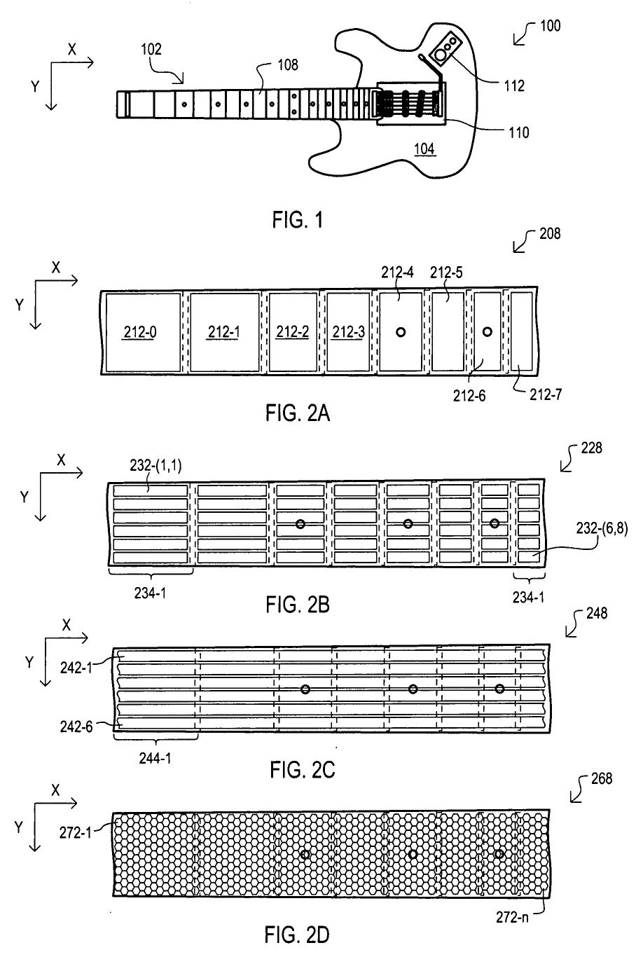

An instrument according to a first embodiment is shown in a top view in FIG. 1, and designated by the general reference character 100. An instrument 100 can include a neck portion 102 and a body portion 104. A neck portion 102 can be an elongated structure longer in a first direction (X in FIG. 1) than in a second direction (Y in FIG. 1). A neck portion 102 can be attached to and extend from a body portion 104. Such an attachment can take a variety of forms and orientations, as will be shown in a few examples below.

A neck portion 102 can include one or more playing surfaces that include capacitive sensors for detecting the touch or proximity of an object, such as a digit of an instrument player. Preferably, capacitive sensors can be formed in an array on a neck portion, including one or more such sensors arranged in the first direction (X), and optionally in the second direction. In the particular example of FIG. 1, instrument 100 can include a playing surface 108 having an array of capacitance sensors.

In the particular example of FIG. 1, a body portion 104 can include a body input section 110. A body input section 110 can include a physical input device for receiving input from a player that is separate from capacitance sensors of neck portion 102. Various examples of possible input devices will be described in more detail below. An instrument 100 can optionally include additional controls 112 for altering output values generated by instrument 100.

In one particular operation, the touch or proximity of a player's fingers can be detected by capacitance sensors on playing surface 108 as input events. Preferably, capacitance sensors can generate a position value from such input events that can be translated into tone values that vary according to position of a sensor. Optionally, input events sensed by playing surface 108 can be translated into “attack” values. Attack values can indicate when and/or how a particular tone starts and/or ends.

Preferably, inputs from a body input section 110 can be utilized to generate attack values for tone generated in response to input events on a playing surface 108. That is, input events on playing surface 108 can establish or modify a tone value, while inputs from a body input section 110 can be utilized to establish when/how such tones a started and/or ended.

When activated by fingers, capacitance sensors on playing surface 108 can be a less painful way to generate tones, as compared to having to press physical strings onto such a surface. This may be particularly beneficial for children, people with small or weak hands, or those with disabilities or who suffer from medical conditions such as arthritis, etc.

FIG. 1 also shows an arrangement in which an instrument does not include strings. As such, an end of neck portion 102 opposite to body portion 104 may not include a headstock. Dispensing with the need for strings can eliminate the need to constantly tune strings and replace strings.

As will be described in more detail below, outputs from an instrument 100 can take various forms. As but a few of the many possible examples, outputs can be an audio signal in analog or digital form. Alternatively, outputs can be in a predetermined digital music format, such as that of the musical instrument digital interface (MIDI). Outputs can also be in a format suitable controller applications, such as input devices to personal computers (PC), gaming consoles, or like applications.

In this way, capacitance sensors can be used lieu of strings to generate sound values in a musical instrument device.

Referring now to FIGS. 2A to 2D, various examples of a playing surface, like that shown as 108 in FIG. 1, are shown in a series of top plan views. FIG. 2A shows an example of a playing surface 208 that includes single row of capacitance sensors 212-0 to 212-7. When an object (e.g., finger) is detected by a capacitance sensor (212-0 to 212-7), such an event can be translated into position information. Thus, in the example of FIG. 2A each different capacitance sensor (212-0 to 212-7) can correspond to a different position location. While embodiments can encompass numerous capacitance sensor row configurations, in the very particular example of FIG. 2A, each capacitance sensor can have a size and orientation dictated by instrument type. Thus, FIG. 2A shows capacitance sensors (212-0 to 212-7) having dimensions in the row direction (shown by X) that generally correspond to particular tone generating positions (e.g., fret divisions of a typical guitar).

In this way, capacitance sensors can be used to generate position information in areas normally occupied by strings of a stringed instrument. In addition, capacitance sensors can occupy areas utilized to generate discrete tones of such an instrument.

FIG. 2B shows another example of a playing surface 228, like that shown in FIG. 1. Playing surface 228 can include multiple rows (in direction X) and columns (in direction Y) of capacitance sensors. Two particular capacitance sensors are shown as 232-(1,1) and 232-(6,8). Like the example of FIG. 2A, while FIG. 2B shows one particular row/column configuration, such an arrangement should not be construed as limiting to the invention. However, the very particular embodiment of FIG. 2B shows how an array of capacitance sensors can have a size and orientation dictated by both instrument type and instrument string arrangement. Thus, FIG. 2B shows columns of capacitance sensors whose position can correspond to tone generating positions (fret areas) and rows of capacitance sensors that can correspond to string positions (in this case six strings). More particularly, capacitance sensor 232-(1,1) can correspond to first string in one fret area 234-1, while capacitance sensor 232-(6,8) can correspond to sixth string in another fret area 238-8.

In this way, capacitance sensors can be used to generate position information in areas normally occupied by strings of a stringed instrument, where such position information corresponds to both a string position, as well as a discrete tone generating areas of such an instrument.

FIG. 2C shows a third example of a playing surface 248, like that shown in FIG. 1. Playing surface 248 can include multiple rows (in direction X) of capacitance sensors, two of which are shown as 242-1 and 242-6. The very particular embodiment of FIG. 2C, shows how an array of capacitance sensors can have a size and orientation dictated by a string arrangement. Thus, FIG. 2C shows rows of capacitance sensors whose positions can correspond to string positions (in this case six strings corresponding to a common guitar configuration, however other numbers of strings may be used such as four for a bass, violin or cello, and five for a banjo etc.). More particularly, capacitance sensor 242-1 can correspond to first string, while capacitance sensor 242-6 can correspond to sixth string. In one very particular arrangement, capacitance sensors (e.g., 242-1 and 242-6) can be “slider” type sensors, providing different signaling information according to point of contact in the longer direction (shown as X in the figure). This may be used to emulate a ‘slide guitar’ style of playing or a fretless instrument such as bass, violin, cello, viola or fretless guitar.

In this way, capacitance sensors can be used to generate position information in areas normally occupied by strings of a stringed instrument according to string position.

Referring now to FIG. 2D, a fourth example of a playing surface 268 is shown in a top plan view. Playing surface 268 can include capacitance sensors arranged in a non-rectangular array, two of which are shown as 272-1 and 272-n. FIG. 2D shows an arrangement of hexagonally shaped capacitance sensors disposed adjacent to one another in a tiled fashion, however, alternate embodiments can include differently shaped sensors. A detected event (e.g., touch) at each different capacitance sensor (e.g., 272-1 and 272-n) can be translated into a different position value. Multiple simultaneous touches may be detected and these positions may be used to provide chord information.

As will be described in more detail below, in an arrangement like that of FIG. 2D, the translation of position information can be programmable, allowing the array to be configured into arbitrarily determined sensing areas.

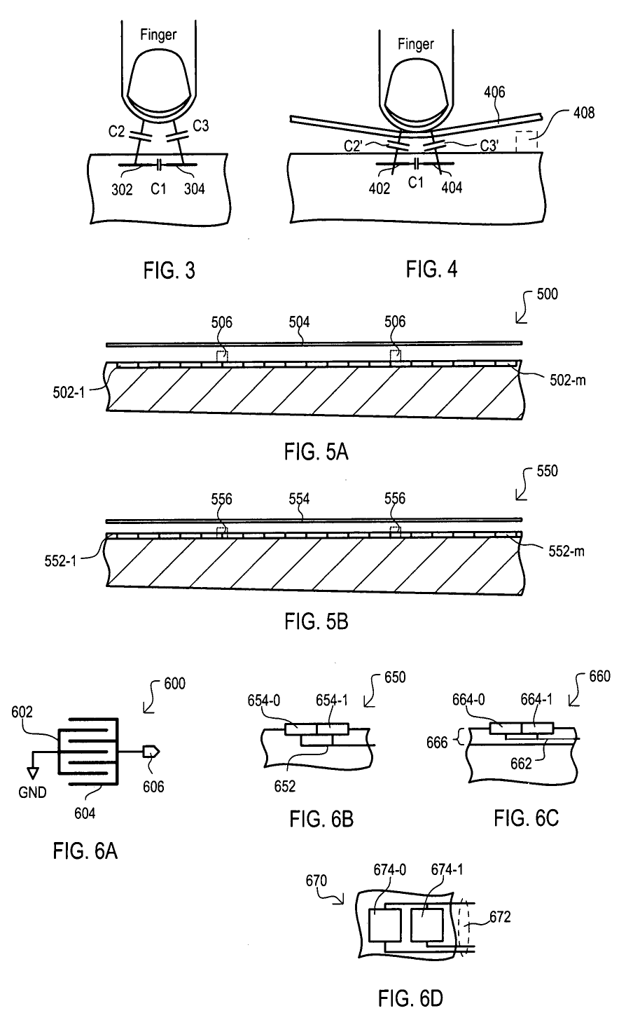

Referring now to FIG. 3, a capacitance sensor that can be utilized in the embodiments will be described. A capacitance sensor can operate by detecting a capacitance between an active switch area and an adjacent grounded area. Two conductive plates 302, 304 (or lines, or some other geometric structure), one of which is active, can have a finite capacitance C1 between them. When a finger (or other conductive surface) is placed in close proximity, the capacitance changes, as shown by capacitance C2, C3.

In this way, capacitance sensors can detect a change in capacitance due to objects in proximity to a playing surface, to thereby detect an input event for an instrument.

While embodiments like those shown in FIGS. 1 to 2D does not include strings, alternate embodiments can include strings formed over a playing surface containing a capacitance sensor array. Such arrangements may be preferable for embodiments utilized for instruction purposes, or the like. Preferably, in such arrangements, strings included on the instrument any are not formed from a conductive material. That is, strings should be composed of, or surrounded by, an insulative material. A common nylon guitar string (often used on classical guitars) may be used for this purpose in one embodiment. Alternatively, a heavier string (with a coated metal core or a non-conductive dense core) could be used. A coated metal string could be formed from a heavy metal core (to replicate the ‘feel’ or a regular strings, particularly for bass strings), coated in a non-conductive material and preferably one that is resistant to abrasion.

Referring now to FIG. 4, an operation of a capacitance sensor utilized in an instrument that includes a string is shown. FIG. 4 includes some of the same general items as FIG. 3, thus like items are referred to by the same reference character but with the first digit being a “4” instead of a “3”. FIG. 4 shows how the bending of a string 406 one or toward a playing surface can result in a change in capacitance due to capacitance C2′, C3′.

While sensing like that of FIG. 4 can be directed to embodiments having the shape of, or otherwise emulating, an instrument without frets (e.g., cello, violin, or bass), other embodiments can be directed to fretted instruments (e.g., a guitar). Thus, a sensing surface may optionally include a fret structure 408.

In this way, capacitance sensors can detect a change in capacitance due to objects in proximity to a playing surface, even when strings are in place over such a playing surface.

Referring now to FIGS. 5A and 5B, two examples of a neck portion for an instrument, such as that shown as 108 in FIG. 1, is shown in a side cross sectional view. Referring to FIG. 5A, a neck portion 500 can include capacitance sensors (two of which are shown as 502-1 and 502-m). FIG. 5A shows an arrangement in which capacitance sensors (502-1 and 502-m) can be embedded into a neck portion 500. As but of few of the many possible examples, a neck portion 500 can include inset areas for receiving the capacitance sensors (502-1 and 502-m). Capacitance sensors (502-1 and 502-m) can be fixed to neck area according to any suitable conventional method, including but not limited to glue or epoxy attachment, or by a mechanical structure such as an overlying plate. Alternatively, capacitance sensors (502-1 and 502-m) can be formed within a circuit board, and the circuit board can be attached to a neck portion. A circuit board can be either rigid or flexible.

In one particular configuration, capacitance sensors (502-1 and 502-m) can be further covered with a protective coating, such as a polychlorotrifluoroehtylene (PTCFE) material, like Aclar® manufactured by Honeywell International, Inc. Other embodiments can include a coating of indium tin oxide (ITO), to name but two examples.

As also shown in FIG. 5A, and as noted previously, a neck portion 500 can optionally include one or more strings 504 disposed over a surface of a neck portion 500. In addition, a neck portion 500 may also optionally include actual fret structures 506. That is, unlike a conventional stringed instrument that must include fret or similar structures for sound generation, embodiments of the present invention can exclude such structures. However, other embodiments may advantageously include fret structures when utilized for instruction purposes, or to provide tactile indications of fret area divisions. This may be modifiable according to player/user preferences in one embodiment.

In this way, capacitance sensors (502-1 and 502-m) can be embedded in, or otherwise formed within a neck portion.

Referring to FIG. 5B, a neck portion 550 according to another embodiment is shown in a side cross sectional view. FIG. 5B shows an arrangement in which capacitance sensors (502-1 and 502-m) can be formed on a surface of an existing neck portion 550. As in the case of FIG. 5A, capacitance sensors (502-1 and 502-m) can be fixed onto a neck portion surface according to any suitable conventional methods, including but not limited to glue or epoxy, a mechanical structure, and/or as a portion of a rigid or flexible circuit board.

In this way, capacitance sensors (502-1 and 502-m) can be formed on an existing neck portion. Such an arrangement can allow such sensors to be readily integrated into an existing instrument structure.

Referring now to FIGS. 6A to 6D, various examples of sensor wiring will now be described. FIG. 6A is diagram showing one example of a capacitance sensor 600. A capacitance sensor 600 can include a first plate 602 that can be connected to one potential node (in this example ground), and a second plate 604 that can be connected to an input node 606. Thus, a capacitance sensed at input node 606 can be used to determine if an input event has occurred.

Wirings can be provided to capacitive sensors according to various ways. A few possible arrangements are shown in FIGS. 6B to 6D. FIG. 6B shows a side cross sectional view of a neck portion 650 which can include wiring formed within the neck portion and connecting to each capacitance sensor (e.g., 654-0 and 654-1).

FIG. 6C shows a side cross sectional view of a neck portion 660 having a circuit board 666 containing wiring 662 for capacitance sensors (e.g., 654-0 and 654-1). A circuit board 666, as noted above, can be a rigid or flexible printed circuit board.

While FIGS. 6B and 6C show arrangements in which wirings can be formed below capacitance sensors, in alternate arrangements, wirings can be situated on the sides of capacitance sensors. One such arrangement is shown in FIG. 6D.

FIG. 6D shows a top plan view of a neck portion 670 containing capacitance sensors (e.g., 674-0 and 674-1). Wiring 672 for such sensors can be disposed to one side or both sides of a sensor.

Wirings to capacitance sensors can extend down the length of a neck to a processing section, which can sense a capacitance at each such sensor or groups of sensors.

In this way, wirings can be provided from capacitance sensors to capacitance sensing circuits.

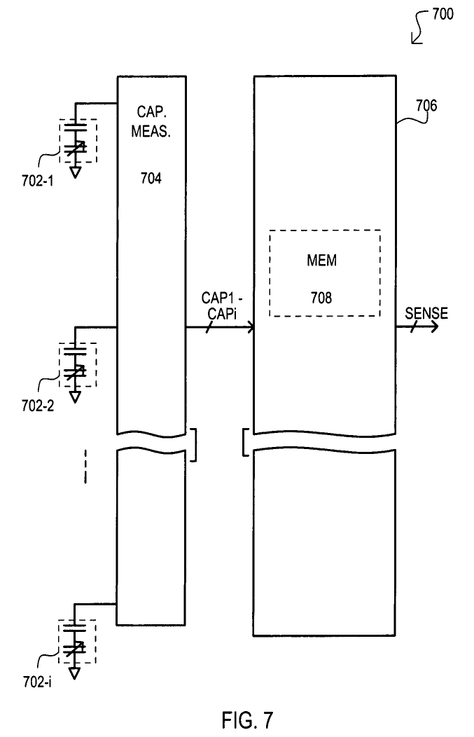

A sensing of the capacitance presented by multiple sensors on a neck portion can be undertaken in various ways. One particular approach is shown in detail in FIG. 7.

Referring now to FIG. 7, a capacitance sense system according to an embodiment is shown in a block schematic diagram and designated by the general reference character 700. As will be described in more detail below, a capacitance sense system 700 can form part of a larger instrument system, and can reside within a neck portion, or preferably within a body portion. Even more particularly, a capacitance sense system 700 can be formed in body portion like that shown as 104 in FIG. 1.

A capacitance sense system 700 can have inputs connected to a number of capacitance sensors 702-1 to 702-i. Each capacitance sensor (702-1 to 702-i) can have a capacitance that can vary depending upon mode of operation. More particularly, each capacitance sensor (702-1 to 702-i) can have a baseline capacitance that exists absent an input event. A baseline capacitance can be essentially constant, but can vary between capacitance sensors (702-1 to 702-i). In a run-time mode (i.e., a mode in which capacitance values are being actively monitored), each capacitance sensor (702-1 to 702-i) can be monitored to detect an input event. As but one example, each capacitance sensor (702-1 to 702-i) can have a run-time capacitance that will drop with respect to a baseline value in the event an object, such as a finger, is in close proximity to the sensor.

A capacitance sense system 700 can include a capacitance sensing section 704 and computation section 706. A sensing section 704 can generate capacitance values CAP1 to CAPi corresponding to each capacitance sensor (702-1 to 702-i).

A sensing section 704 preferably generates numerical values as capacitance values (CAP1 to CAPi), even more preferably, generates count values based upon a charging of a capacitance sensor. A sensing section 704 can include a sensing circuit for each input, but may preferably multiplex (MUX) inputs to a common sensing circuit.

In the event a sensing section 704 utilizing a charging rate of a capacitance as a measurement, a sensing section 704 can include one or more charging sources (e.g., current sources). In particular, one charging source may be spread among capacitance sensors in a multiplexed approach, or individual charging sources may be provided to each capacitance sensor. A charging source can take any of a number of possible forms. In one simple approach, a charging source can be a resistor that is connected directly, or by way of a switching arrangement, between a capacitance sensor and a high power supply node. Alternate approaches can include current digital-to-analog converters (current DACs), or reference current sources biased according to well known temperature independent techniques (band-gap reference, etc.).

A computation section 706 can execute predetermined arithmetic and/or logic operations. In a run-time mode, a computation section 706 can receive run-time capacitance values (CAP1 to CAPi) corresponding to each capacitance sensor (702-1 to 702-i). A computation section 706 can compare each run-time capacitance values to the corresponding baseline capacitance values. Sense results can then be compared to threshold values to determine if an input event has occurred.

In one very particular result, baseline and run-time capacitance values can be count values. A computation section 706 can subtract a run-time value from a baseline value to arrive at a raw sense result. The difference value can then be utilized to determine if an input event has occurred.

In this way, capacitance values for a number of capacitance sensors can be sensed to determine if an input event has occurred.

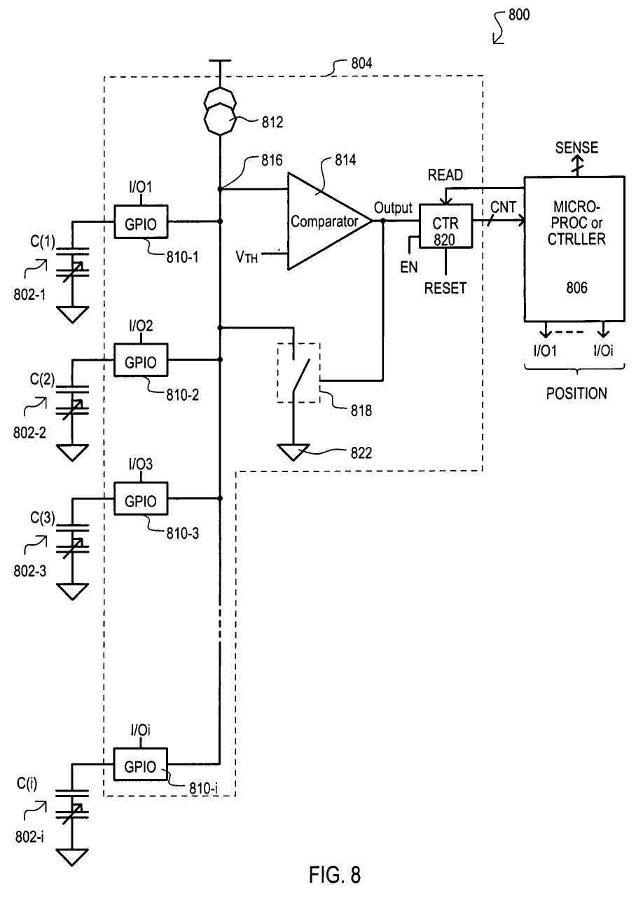

Referring now to FIG. 8, a capacitance sense system according to a second embodiment is shown in a block schematic diagram and designated by the general reference character 800. A system 800 can include some of the same general sections as FIG. 7, thus like sections are referred to by the same reference character, but with the first digit being an “8” instead of a “7”.

In the embodiment of FIG. 8, a sensing section 804 can include a number of general purpose input/output (GPIO) cells 810-1 to 810-i, a current source 812, a comparator 814, a reset switch 818, and a counter 820. Each capacitance sensor (802-1 to 802-i) can be tied to a corresponding GPIO cells (810-1 to 810-i). Individual GPIO cells (810-1 to 810-i) can be connected to a common bus 816 in a multiplexer type fashion. GPIO cells (810-1 to 810-i) can each be controlled by corresponding I/O signals I/O1 to I/Oi.

Current source 812 can be connected to common bus 816 and provide a current. Such a current can be constant current when making capacitance measurements. Preferably, current source 812 can be programmable to accommodate variations in a sensed capacitance value. Reset switch 818 can be connected between common bus 816 and a low power supply node 822. Reset switch 818 can be controlled according to an output of comparator 814.

Comparator 814 can have one input connected to common bus 816, a second input connected to a threshold voltage V_{TH} and an output connected to reset switch 818 and to counter 820.

Counter 820 can be a gated counter that can accumulate transitions at the output of comparator 814. In particular, in response to an enable signal EN, counter 820 can perform a counting operation. In response to a reset signal RESET, counter 820 can reset a count value to some predetermined starting value (e.g., 0). In response to a read signal READ, counter 820 can output an accumulated count value CNT. In one very particular arrangement, a counter 820 can be a 16 bit timer with an externally triggered capture function.

In operation, compare section 804 can multiplex capacitance readings by sequentially enabling (e.g., placing in a low impedance state) GPIO cells (810-1 to 810-i). While one GPIO cell is enabled, current source 812 can charge the capacitance of the corresponding capacitance sensor. Once a potential at common bus 816 exceeds voltage V_{TH}, an output of comparator 812 can transition from an inactive to active state, turning on reset switch 818, thus discharging common bus 816. The process can repeat to generate an oscillating signal at the output of comparator 814. Such an oscillation rate can be counted by counter 820 over a predetermined time period to generate a count value. Once a count value has been acquired from one capacitance sensor, the current GPIO cell can be disabled and a new GPIO cell enabled. The operation can then be repeated to generate count values for all capacitance sensors of interest. In this way, capacitance values can be acquired for all capacitance sensors (802-1 to 802-i).

Referring still to FIG. 8, in one particular arrangement, the number of counts can be inversely proportional to the value of the switch capacitance (C_{P}). In a touch sensor arrangement, when a finger is placed on a capacitive switch, the capacitance goes up to C_{P}+C_{F} and thus the number of counts can decrease. An input event (i.e., finger touch or proximity) can be detected by comparing a count value generated by the input event, to a count value generated without such an event.

A calculation section 806 can generate position information based upon readings generated by capacitance sensors (802-1 to 802-i). Optionally, a calculation section 806 can perform additional functions in the sense operation, including but not limited to acquiring baseline values (i.e., count values absent an input event) for any or all of capacitance sensors, generating correction factors for all or selected capacitance sensors to account for variations between capacitance sensors (assuming uniformity is desired) or to introduce variations in sensing functions between such sensors. A calculation section 806 can include a microprocessor core or microcontroller that receives count values from counter 820, and executes arithmetic operations to generate position information and other functions. In the arrangement of FIG. 8, calculation section 806 can also output I/O signals (I/O1 to I/Oi) to control the multiplexing measurement of capacitance sensors. Such I/O signals can correspond to capacitance sensor position information.

It is noted that multiple capacitance sensing systems, such as those shown in FIGS. 7 and 8 can be utilized in parallel, with different systems monitoring different sets of capacitance sensors. This can increase overall sensor scan speed, and hence increase the response time of a capacitance sense operation. Alternatively, multiple such capacitance sensing systems may be needed for higher resolution capacitance sensor arrays.

In addition or alternatively, a capacitance sensing system can scan subsets of the total number of capacitance sensors, to increase a scan speed over one area of an array. Even more particularly, once an input event has been detected, scan operations can be limited to a subset of capacitance sensors within a predetermined area surrounding the capacitance sensor(s) detecting the input event. This predetermined area could in one embodiment include the width of a human hand, representing the maximum reach either up or down the guitar neck that a player could have.

Of course, a microprocessor core represents but one type of calculation section. Alternate embodiments could be realized by an application specific integrated circuit (ASIC), microcontroller, or programmable logic device, to name but a few examples.

Preferably, a system 800 can be formed with one or more PSoC® mixed signal array made by Cypress Semiconductor Corporation of San Jose, Calif.

It is noted that while the above described embodiments can utilize a relaxation oscillator approach to generating capacitive sense values, other embodiments can use different capacitance sensing approaches. For example, an alternate sensing configuration can use a switched capacitor and a sigma delta modulator. One example of such an approach is shown in “Migrating from CSR to CSD”, by Ted Tsui an Application Note published by Cypress Semiconductor Corporation, the contents of this article are incorporated by reference herein.

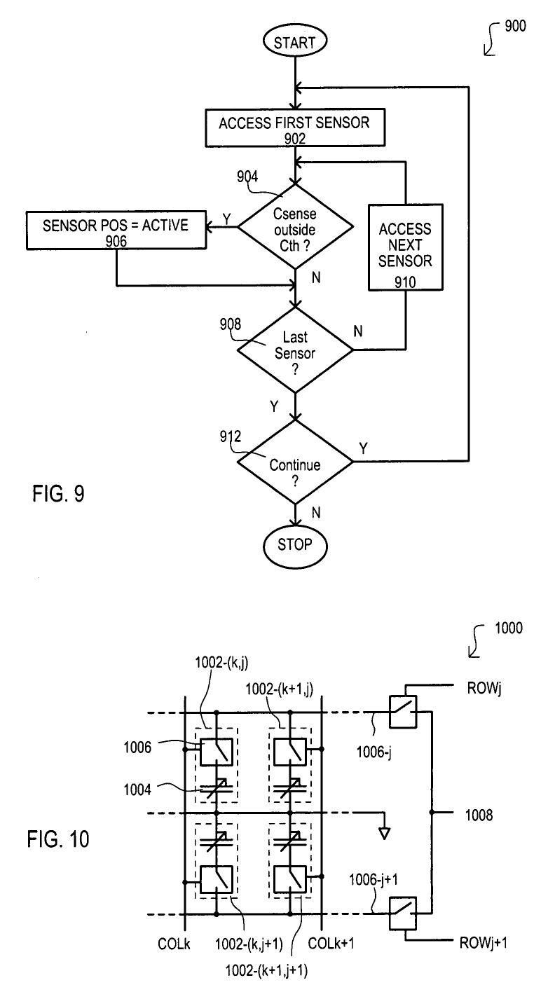

Referring now to FIG. 9, a method for sensing capacitance values that can be executed by systems like those shown in FIGS. 7 and 8 is shown in a flow diagram and designated by the general reference character 900.

A method 900 can include accessing a first sensor (step 902). Such a step can include activating a first capacitance sensor and/or enabling an electrical path to such a sensor. A capacitance for the sensor (Csense) can be compared to a threshold capacitance value (Cth) (step 904). A threshold value (Cth) can be a single value, a range, and can be fixed or variable depending upon the particular application. In one very particular arrangement, a step 904 can include comparing one or more count values, generated by a relaxation type oscillator circuit, to a threshold count value. If a measured capacitance value is outside a threshold (Y from 904), a sensor position corresponding to the capacitance sensor can be indicated as active (step 906).

Referring still to FIG. 9, if a measured capacitance value is not outside a threshold (Y from 904), a method can determine if a last sensor has been reached (step 908). If a last sensor has not been reached (N from 908), a method 900 can access a next sensor (step 910), and return to step 904. If a last sensor has been reached (Y from 908), a method 900 can determine whether sensing operations are to continue (step 912). If sense operations are to continue (Y from 912), a method can return to step 902.

In this way, a method can sense capacitance values for multiple sensors of an instrument.

While some embodiments can provide a sensing signal path between each capacitance sensor and a sensing system, alternate arrangements can share such paths. One very particular example of such an approach is shown in FIG. 10.

Referring now to FIG. 10, a capacitance sensor array is shown in a block diagram and designated by the general reference character 1000. An array 1000 can include a number of sensor units (1002-(k,j) to 1002-(k+1,j+1)) arranged into rows and columns. Each sensor unit (1002-(k,j) to 1002-(k+1,j+1)) can be selectable according to a row signal and column signal. For example, in the particular case of FIG. 10, sensor unit 1002-(k,j) can be selected by activating signal ROWj and signal COLk.

In the particular embodiment of FIG. 10, each sensor unit can include a capacitance sensor (one shown as 1004) and a corresponding switch (one shown as 1006). A switch 1006 can be activated by a first type select signal (e.g., COLk), and thereby connect the corresponding capacitance sensor 1004 to a sense line (in this case 1007-j). Any of multiple sense lines (e.g., 1007-j and 1007-j+1) can be connected to a shared sense node 1008 by a second type select signal (e.g., ROWj, ROWj+1).

In this way, capacitance sensors of an array can be selectable in a row and/or column wise fashion. It is noted that while FIG. 10 shows an array having rows and columns, other arrangements may include but one row or one column.

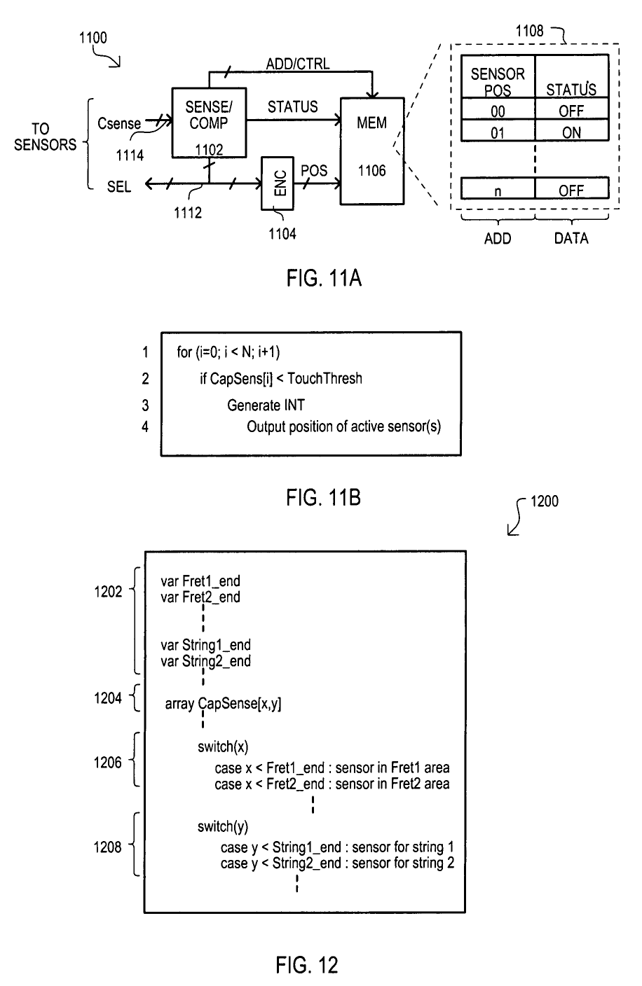

In addition to sensing capacitance values for sensors, a computation section, such as that shown as 706 or 806 in the above embodiments, can generate position and status information for such sensors. Two possible examples of such operations are shown in FIGS. 11A and 11B.

Referring now to FIG. 11A, a capacitance sense system according to one embodiment is shown in a block schematic and designated by the general reference character 1100. A system 1100 can include a sense and computation section 1102, an encoding section 1104, and a memory 1106. A sense and computation section 1102 can output select values SEL on select outputs 1112 to select one or more capacitance sensors. In response to such select values SEL, capacitance values Csense can be provided from such sensors to sense and computation section 1102 via sense inputs 1114. A sense and computation section 1102 can also generate one or more sensor status indications STATUS according to sense results. For example, if a capacitance value is determined to indicate an input event for a given capacitance sensor (or group of such sensors), a STATUS indication can be active. A STATUS indication(s) can be stored in a memory 1106.

An encoder 1104 can utilize select values to generate a position value POS. A position value POS can be stored in a memory 1106. Of course, a position value can be generated according to various other means. For example, a count value may be utilized to cycle through and sample each capacitance sensor (or sensor group) that is reset once all sensors have been sampled. Such a count value can be used to generate a position value (i.e., the system is known to be sampling a particular sensor at any given time).

Preferably, a memory 1106 can maintain a record of capacitance sensor status according to position. One very particular example of such an arrangement is shown as 1108. A sensor position value can be identified by an address, while a status value can be data. It is noted that a single addressable location can store the status for multiple capacitance sensors. As but one very particular example, an addressable 16-bit data value could contain the status for sensor positions 1-16, while a 16-bit value at the next sequential address could contain the status for sensor positions 17-32, etc. Such values can then be accessed to detect input events on a playing surface of an instrument.

In this way, capacitance sensor position and status values can be stored and retrieved.

While capacitance sense values can be stored, and hence reside in a passive fashion, such values can also be used for active notification of when an input event occurs. An example of such an approach is shown in FIG. 11B.

FIG. 11B is a diagram showing one approach for generating an indication when an input event is detected. FIG. 11B is described in “pseudocode,” a broad way of expressing the various steps in a method and/or functions of system. The pseudocode may be implemented into particular computer language code versions for use in a system having a general processor or specialized processor. In addition, the described method can be implemented in a higher level hardware designing language, to enable the preferred embodiment to be realized as an application specific integrated circuit (ASIC) or a portion of an ASIC, a programmable logic device, or portion of a programmable logic device.

Referring to FIG. 11B, line 1 shows a cycling through N values, where N is a number of capacitance sensors sampled. Line 2 shows a comparison step that can be performed on each capacitance value of a sensor CapSense[i]. If a sensed value falls below a given threshold TouchThresh, an interrupt can be generated (line 3). Optionally, position information for the sensor can be output (e.g., written to a register or other storage location) (line 4).

In this way, input events can be indicated by an output signal.

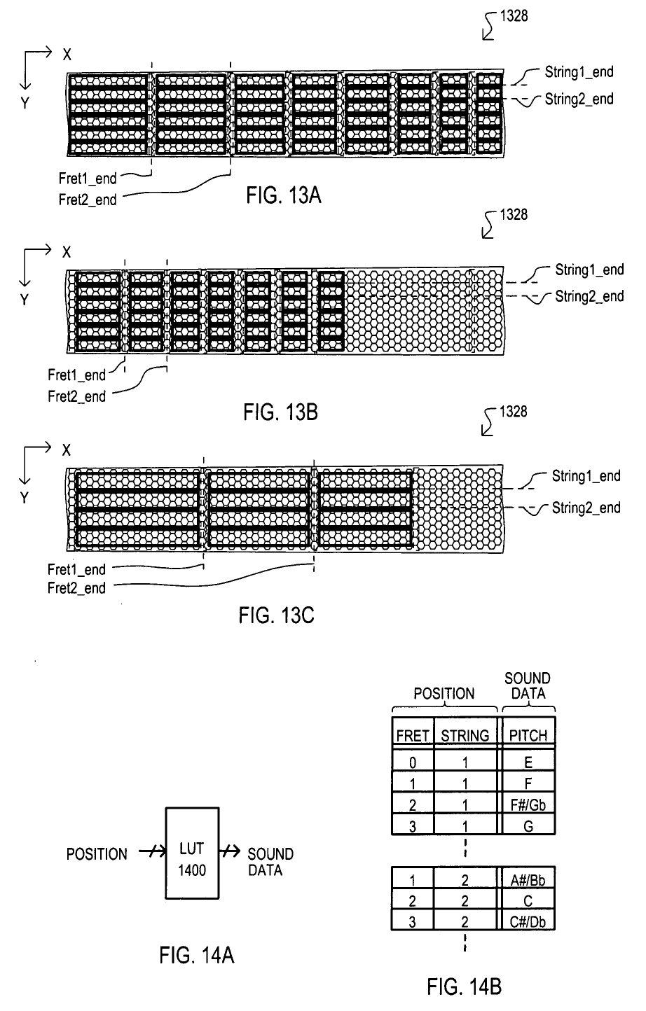

As noted above, while a capacitance array can provide position information, such position information can be programmable. As but one example, the position value provided by sensors can be grouped into sections, with a detected event at any of the sensors within a section being translated into an event for the area covered by the section. One very particular example of such an arrangement is shown in FIGS. 12 and 13A to 13C. FIG. 12 is a pseudocode representation 1200 showing programmability of position information.

In an approach like that of FIG. 12, one or more variables can be defined that indicate partitions in an array of capacitance sensors. In the particular example show, values Fret1_end, Fret2_end, String1_end and String2_end can be variables selected by a user or application (see section 1202). As but one very particular example, values Fret1_end and Fret2_end can demarcate where one fret region of a guitar or guitar like instrument ends, while values String_end and String2_end can demarcate where different string areas exist for the guitar or guitar like instrument.

Referring still to FIG. 12, each capacitance sensor can be identified by an array CapSensor[x,y] value (section 1204). Depending upon the particular array value, a capacitance sensor will be mapped to a particular section.

In the example of FIG. 12, according to an “x” value, a capacitance sensor will indicate a particular area on a neck portion (section 1206), which can be a fret area in one particular example. Similarly, according to a “y” value, a capacitance sensor will indicate another area on a neck portion (section 1208), which in this case can be a string area.

FIGS. 13A to 13C shows various arrangements in which capacitive sensors can be logically grouped into sections, with position information from sensors of the same section being translated into a same position value. Each of FIGS. 13A to 13C shows an example of a playing surface 1328 like that shown as 268 in FIG. 2D. Playing surface 1328 can include numerous capacitance sensors, each having a different x,y position (indicated by direction arrows in the figures). Further, each example corresponds to the approach illustrated by FIG. 12, but with different variable values.

FIG. 13A shows an arrangement in which capacitance sensors can be logically arranged to define string and fret areas that essentially follow that of a guitar. Limits created by variables Fret1_end, Fret2_end, String1_end and String2_end are shown in the figure.

FIG. 13B shows an arrangement in which capacitance sensors can be logically arranged to define string and fret areas that also follow that of a guitar, but scaled smaller than the case of FIG. 13A. Such an arrangement can allow players with smaller hands to span a greater number of fret areas, or can allow a wider pitch range for an instrument than that provided in the typical stringed versions.

FIG. 13C shows an arrangement in which capacitance sensors can be logically arranged into arbitrarily to define areas. The example shows an arrangement that forms areas for four strings, and uniformly sized fret areas.

It is understood that a very large number of different configurations can be accommodated.

In this way, capacitance sensors can be logically arranged into groups based on programmable values.

According to the above embodiments, an instrument can generate position information based on input events sensed at a neck portion of such an instrument. This can enable the instrument to serve as a controller for various functions, including but not limited to electronic gaming, digital music composition, music instruction, and music production. Embodiments directed to such various applications will now be described.

For musical production and/or digital music composition, variations in position information of capacitance sensors can be translated into variations in a sound values (e.g., different tones or pitches, etc.). Two possible examples of such sound value generation are shown in FIGS. 14A and 14B and described below.

Referring now to FIG. 14A, a sound generation circuit is shown in block schematic diagram and designated by the general reference character 1400. A circuit 1400 can be a look-up table (LUT) that can receive position values, and in response thereto, output a sound value. FIG. 14B shows one very particular example of possible LUT entries. FIG. 14B shows an arrangement in which position data can correspond to a fret area value and a string number. Each different value can index to a particular pitch. While FIG. 14B shows an arrangement for a western guitar tuning, sound values can be programmable to numerous arbitrary configurations.

While sound generation can implemented with a direct indexing, such as that shown by FIGS. 14A and 14B, other approaches can calculate a sound value based on an arithmetic operation executed on input data. For example, a sound value can vary according to X position (which can be oriented in the longer direction of a neck portion). In the particular example shown, sound can be generated according to the relationship:

pitch=pitch_base+position[x]*K

where “pitch” can be resulting pitch value, “pitch_base” can be a baseline pitch value, “position[x]” can be an x position of a capacitance sensor receiving an input event, and “K” can be a constant.

A variation on the above can utilize position information generated by logical groupings to generate sound. A different sound can be generated for each string position:

pitch_stringY=base_pitchY+(step_half*fretarea#)

where “pitch_stringY” can be a pitch value for a given string, and Y can be different for each different string (e.g., Y ranges from 1 to 6 for emulation of a standard guitar, Y ranges from 1 to 4 for standard bass guitar, etc.). A value “base_pitchY” can be a baseline pitch for a given string. A value “fretarea#” can be an encoded position value generated according to an “x” position. A value “step_half” can be a half step.

In this way, detected input events at a capacitance sensor array can be translated into sound value.

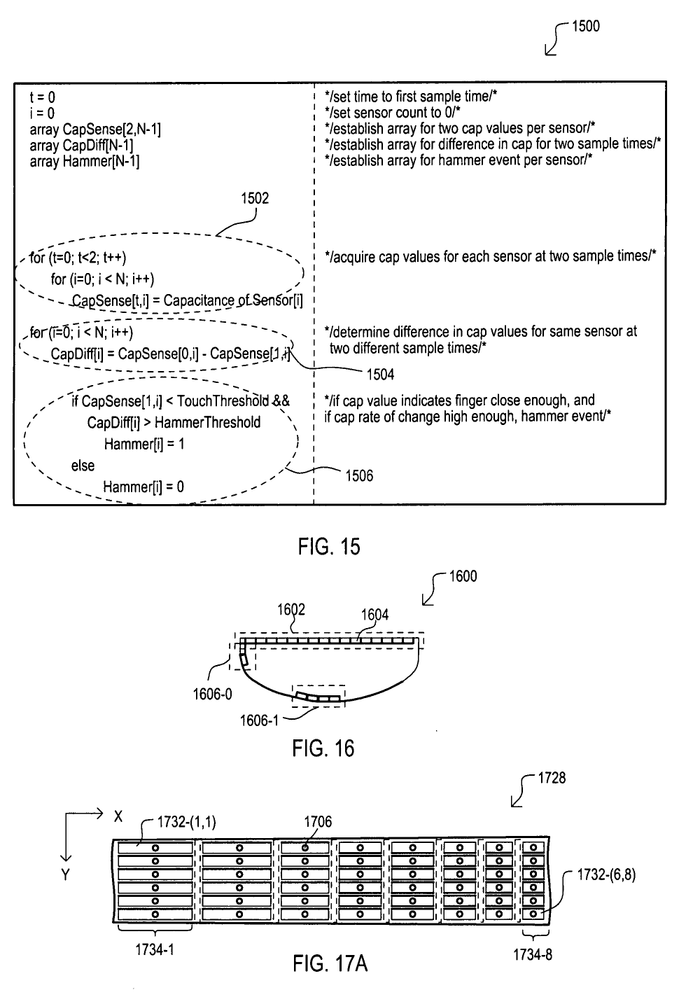

While a neck portion can detect input events according to one or more threshold values, in other embodiments, other types of events can be detected based on rates of change in capacitance. When an object approaches or leaves a playing surface at a particular speed, a detected capacitance can change (e.g., suddenly drop or rise in capacitance). Such an event can be categorized as a different type of input. As but one very particular example, input events of low velocity can be tone establishing events, analogous to placing a finger onto a string to establish the tone generated by the string, with a subsequent “attack” event on the string (e.g., strum, pick, etc.) dictating when the tone starts and/or ends. In contrast, input events of higher velocity can be considered “attack” events, that can indicate a start of a tone (e.g., “hammer” or “pull-off” movement in the case of a guitar). One example of such an approach is shown in FIG. 15.

FIG. 15 shows an approach in pseudocode that can detect input events based on change in capacitance. Capacitance sensors can be sampled for two time periods, t=0 and t=1 (section 1502). A difference in capacitance for each capacitance sensor can be ascertained (section 1504). Such a difference can represent a change in capacitance over the time period from time t=0 to time t=1.

If a capacitance value indicates an input event and a change in capacitance is sufficiently rapid, the input invent can be indicated as being a sound generating event. In the very particular example of FIG. 15, this is shown in section 1506, and can include establishing that a capacitance is sufficiently low enough to indicate an input event (CapSense[1,i]<TouchThreshold) and, at the same time, the detected difference in capacitance is sufficiently large to indicate a high velocity event (CapDiff[i]>HammerThreshold). If this is the case, a particular indication can be generated for the event. Such an indication can be used to for sound activation, and opposed to only establishing a sound type.

While FIG. 15 shows the generation of a sound activation value according to an object approaching a playing surface (e.g., emulate “hammering” in the case of a guitar), other embodiments can generate sound indications according to objects leaving or moving sideways with respect to a playing surface (e.g., emulating a “pull-off” in the case of a guitar). For example, such an event can be detected by a capacitance at one or more sensors increasing faster than a predetermined rate.

In this way, a capacitance sensor array can be monitored for events that both establish a sound type, as well as events that establish the activation of a sound.

Referring back to FIG. 1, in the very particular embodiment shown, a playing surface can corresponding to a surface below which strings are, or would exist in a typical stringed instrument. However, alternate embodiments can include playing surfaces or input surfaces on other locations of a neck portions. One of the many possible configurations is shown in FIG. 16.

FIG. 16 shows a cross sectional view of a neck portion 1600 taken along a shorter dimension direction (e.g., Y in FIG. 1). A neck portion 1600 includes a playing surface 1602 that can include an array of capacitance sensors (one of which is shown as 1604). However, a neck portion 1600 can include one or more additional capacitance sensor areas (in this case, two such areas shown as 1606-0 and 1606-1) located on other surfaces of a neck portion. As but one very particular example, one set of capacitance sensors (e.g., 1606-0 and/or 1606-1) can be arranged in at one or more locations accessible by one or more digits (e.g., thumb), while a playing surface 1602 can be accessible by other digits (e.g., fingers other than the thumb).

Additional capacitance sensors (e.g., 1606-0 and/or 1606-1) can be utilized in the same fashion as those of a playing surface 1602, such as establishing a sound or indicating the generation of a sound. Alternatively, such additional capacitance sensors (e.g., 1606-0 and/or 1606-1) can provide additional control inputs to an instrument for other purposes.

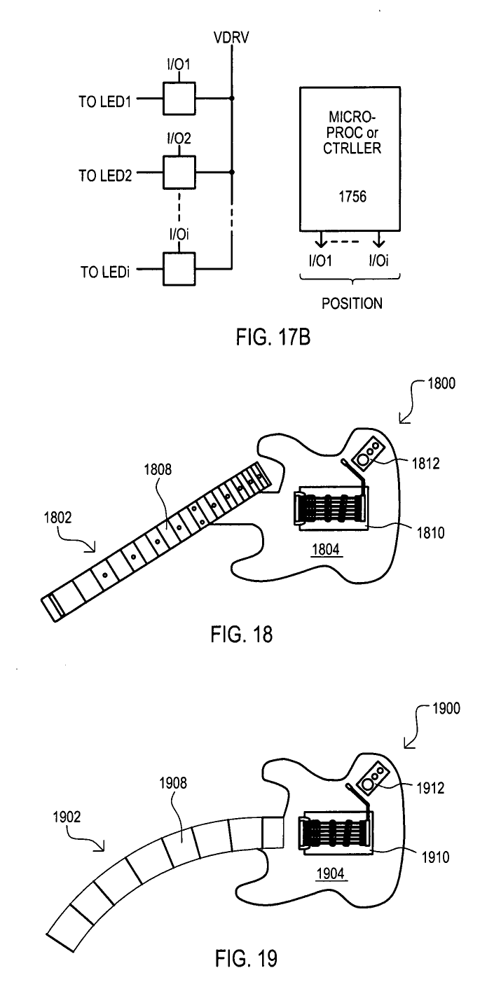

For musical instruction applications, capacitance sensors can be used to provide feedback to indicate finger position for an instrument. That is, during instruction, an input event can be expected at a given capacitance sensor, or group of sensors. A computation section (e.g., 706 or 806) can provide an indication when an input event is detected. For more effective instruction it may be desirable to provide visual indicators that can identify one or more particular regions on a playing surface. Examples of such an arrangement are shown in FIGS. 17A and 17B. FIG. 17A shows a top plan view of neck portion 1728 that can include some of the same general items as FIG. 2B, thus like items are referred to by the same reference character but with the initial digits being “17” instead of “2”.

Unlike the arrangement of FIG. 2B, a neck portion 1728 can include an indicator (one shown as 1706) corresponding to particular locations on a playing surface. The very particular example of FIG. 17 shows one indicator for each capacitance sensor. Preferably, an indicator can be a light emitting diode (LED).

FIG. 17B shows one very particular example of how indicators can be driven by control circuits like those shown in FIG. 8. Additional I/Os can be included that provide driving paths to indicators in the same way that sensing paths can be provided from capacitance sensors. In addition, in particular arrangements, a same decoding scheme can be utilized for both sensing and indicator activation. That is, the same signal generating method utilized to acquire a capacitance value from a sensor can be used to drive an indicator corresponding to such a sensor.

It is understood that while FIG. 17A shows an arrangement in which one indicator can be provided for each capacitance sensor, alternate embodiments can include different arrangements. For example, one indicator can be provided for multiple capacitance sensors, and vice versa.

As noted above, embodiments of the invention, like that shown in FIG. 1, can advantageously eliminate strings, while retaining touch input locations corresponding to strings. Because strings do not have to be tensioned between a neck portion and body portion, in embodiments of the present invention a neck portion of an instrument can be arbitrarily shaped or arbitrarily oriented with respect to a body portion. Two of the numerous possible variations are illustrated by very particular examples in FIGS. 18 and 19.

FIG. 18 shows a top plan view of an instrument 1800 that can include some of the same general items as FIG. 1, thus like items are referred to by the same reference character but with the initial digits being “18” instead of “1”. Unlike FIG. 1, an instrument 1800 can include a neck portion 1802 oriented at an angle with respect to that of conventional instrument arrangements.

FIG. 19 shows a top plan view of an instrument 1900 that can also include some of the same general items as FIG. 1, thus like items are referred to by the same reference character but with the initial digits being “19” instead of “1”. Unlike FIG. 1, an instrument 1900 can include a neck portion 1902 having a non-linear shape. FIG. 19 shows an arrangement with a curved neck Of course various other non-linear neck arrangements are possible, including non-contiguous neck portions (a neck portion having more than one separate piece).

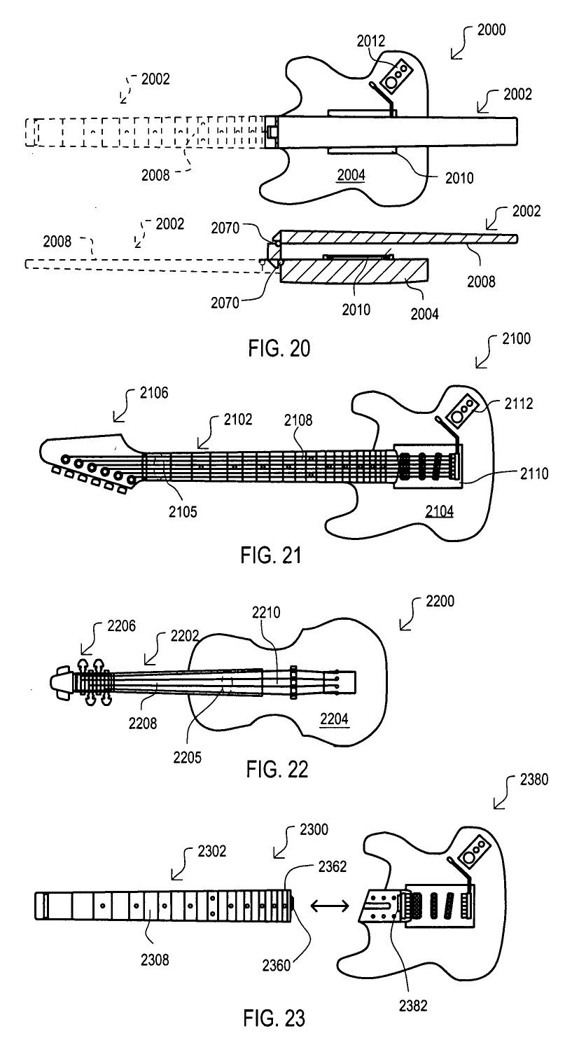

Because strings can be excluded from a neck portion, embodiments of the present invention can be more compact by including a neck portion that articulates with respect to a body portion. One particular example of such an arrangement in shown in FIG. 20.

FIG. 20 shows a top plan view and a side cross sectional view of an instrument 2000 that can also include some of the same general items as FIG. 1, thus like items are referred to by the same reference character but with the initial digits being “20” instead of “1”. Unlike FIG. 1, an instrument 2000 can include a neck portion 2002 that can be folded back onto a body portion 2004. Thus, an instrument 2000 can include one or more joints (2070) that can allow a neck portion to be physically moved (i.e., swiveled, rotated), with respect to a corresponding body portion. Of course, the particular articulating arrangement of FIG. 20 shows but one of many possible configurations. As but a few examples, a neck portion could in an opposite direction, or rotate in plane different from that shown in FIG. 20.

Because strings are not included in the embodiment of FIG. 20, in order to play the instrument, the neck portion can be moved into an extended position and the instrument can be ready to be played, without having to add and tension strings.

It is understood that FIGS. 18 through 20 are but examples of many possible variations.

As also noted above, embodiments of the invention, like that shown in FIG. 1, can advantageously include strings in conjunction with capacitance sensor. Thus, other embodiments can have the same shape and/or features of a typical conventional instrument but with the added capabilities provided by capacitance sensing. Two of the numerous possible variations are illustrated by very particular examples in FIGS. 20 and 21.

FIG. 21 shows a top plan view of an instrument 2100 that can include some of the same general items as FIG. 1, thus like items are referred to by the same reference character but with the initial digits being “21” instead of “1”. Unlike FIG. 1, an instrument 2100 can include strings 2105 and hence may optionally include a headstock 2106 for tensioning such strings. However, it is noted that such strings are preferably not conductive. The very particular example of FIG. 21 shows an instrument 2100 having a configuration like that of a conventional electric guitar.

FIG. 22 shows a variation on the arrangement shown in FIG. 20. Like items are referred to by the same reference character but with the initial digits being “22” instead of “20”. FIG. 22 shows an instrument 2200 having a configuration like that of a conventional violin. FIG. 22 illustrates that while particular instrument types may have greater commercial success and address long felt needs in the fields of game controllers, musical composition, musical production, and/or musical instruction, the invention should not necessarily be construed as being limited to any particular instrument type or shape.

While some of the above embodiments have illustrated the invention in terms of an instrument composed of both a neck portion and body portion, alternate embodiments can include an instrument having neck portion without a body portion. One such arrangement is illustrated in FIG. 23.

FIG. 23 shows an instrument 2300 that can include neck portion 2302 with a playing surface 2308. A playing surface 2308 can correspond to any of those shown in the above embodiments. A neck portion 2302 can be mechanically compatible with existing conventional body portions 2380, and thus include an attachment area 2362 (understood to be on a side opposite to a playing surface 2308). An attachment area 2362 can enable a neck portion to be connected to a body portion 2380 at a body attachment location 2382. Preferably, an attachment area 2362 can be conventionally shaped to enable a neck portion 2302 to be interchangeable with existing instrument necks.

FIG. 23 also shows how a neck portion 2302 can be removeable from a body portion. This feature allows an instrument to be advantageously compact. A neck portion 2302 can be removed from a body portion. However, once reattached, the instrument can be ready to be played, dispensing with the need to add and tune strings.

An embodiment like that of FIG. 23 can also allow a neck portion 2302 having a capacitance sensing playing surface 2308 (which can be considered a “smart” neck) to be incorporated with existing guitar bodies. Such an instrument configuration can generate position (e.g., note) information (useful in MIDI applications) at the same time as an audio signal. In such a very particular configuration, strings preferably include a conductive core with a nonconductive coat. This can enable conventional magnetic pickups to generate sounds from the strings, while at the same time enabling capacitance sensing on the neck portion 2302.

In particular embodiments, circuits like those shown in FIGS. 7, 8, 14A, 14B and/or those for executing operations like those shown in FIGS. 9, 11A, 11B, 12, 15A, 15B, can be included within a neck portion.

In this way, a neck portion having capacitance sensing according to the embodiments, can be easily incorporated with existing instrument body types.

Referring still to FIG. 23, alternatively, processing circuits can be included in a body portion. In one particular arrangement, a neck portion 2302 can include an electrical connector 2360 compatible with a receiving connector 2382, formed on body portion 2380. An electrical connector 2360 can provide electrical paths between capacitance sensors within a neck portion 2302 and processing circuits physically located in a body portion, or external to the instrument.

In this way, a neck portion can include an electrical connector that interfaces with a body portion that can provide an electrical path to capacitance sensors located within the neck portion.

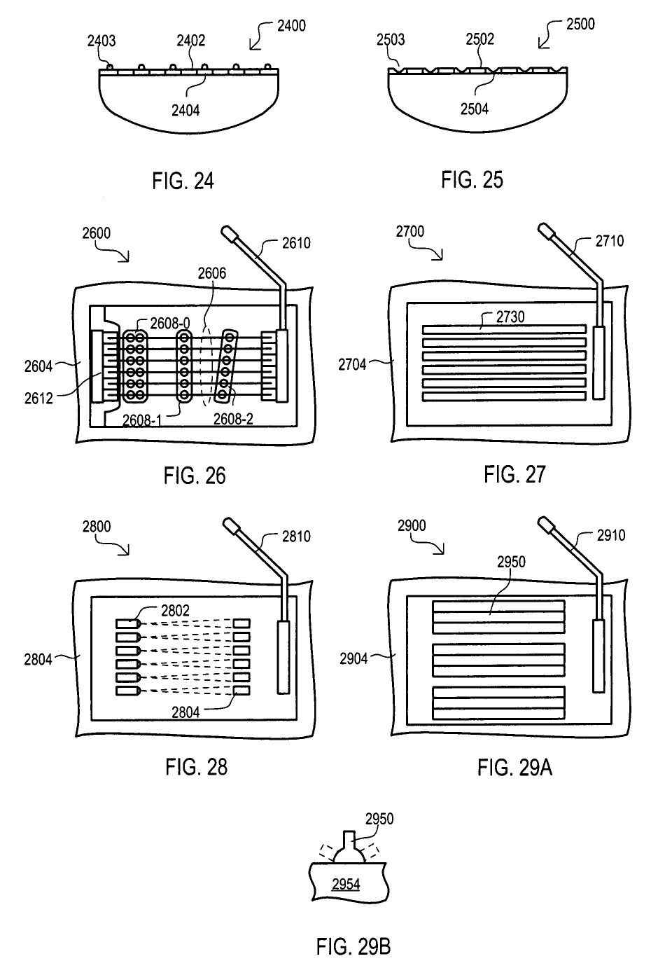

While embodiments of the invention may eliminate the need for strings, in some cases it may be desirable to provide some tactile indication of conventional string locations, without the complexity of actual strings. Two embodiments showing such an arrangement are shown in FIGS. 24 and 25.

FIG. 24 shows a cross sectional view of a neck portion 2400 taken along a shorter dimension direction (e.g., Y in FIG. 1). A neck portion 2400 includes a playing surface 2402 that can include an array of capacitance sensors (one of which is shown as 2404). However, a neck portion 2400 can include ridges (one shown as 2403) extending upward from a playing surface 2402 below locations where strings would be situated in a stringed version of an instrument. It is understood that ridges (e.g., 2403) can extend the length of a neck portion, in an unbroken or continuous form.

FIG. 25 shows a cross sectional view of a neck portion 2500, like that of FIG. 24. FIG. 25 can include the same general items and FIG. 24, but instead of ridges, it can include grooves (one shown as 2503). Grooves (e.g., 2503) can extend into a playing surface 2502 below locations where strings would be situated in a stringed version of an instrument. As in the case of the ridges of FIG. 24, grooves (e.g., 2503) can extend the length of a neck portion, in an unbroken or continuous form.

Of course other embodiments can include different types of tactile indicators. As but a few of the many possible alternate arrangements, tactile indicators can include discrete features that extend from, or into a playing surface, such as dots or divots. Such discrete features can be aligned with one another. Still further, tactile indicators can include variations in texture, with one or more portions of a playing surface being having a different feel than the other (e.g., differences in pattern, or roughness).

In this way, an instrument having capacitance sensors in a neck portion can exclude strings, but include tactile indicators at typical string locations.

In addition to providing capacitance sensing to establish a sound value, or in some cases a sound generation value (i.e., hammer/pull-off emulation), a sound generation value can also be generated at a body input section. Various examples of body input sections are shown as 110 in FIG. 1, 1810 in FIG. 18, 1910 in FIG. 19, 2010 in FIG. 20, 2110 in FIG. 21, 2210 in FIG. 22, or 2384 in FIG. 23. More detailed examples of possible body input sections will now be described.

FIG. 26 shows a first example of a body input section 2600 that can be used in conjunction with capacitance sensing in a neck portion. A body input section 2600 can be formed on a body portion 2604. Body input section 2600 can include the same physical structure as a conventional electric instrument, including strings 2606 and one or more transducers (2606-0 to 2606-2) (e.g., pick-ups) for detecting string vibration. In such an arrangement, strings 2606 can be conductive. However, in the case of FIG. 26, strings 2606 can terminate within a body portion and not extend along a neck portion. Further, 2606 because capacitance sensing can establish a sound value (tone, pitch, etc.), strings 2606 do not have to be tensioned to any particular resonant frequency, as they may be used for the generation of sound activation values, rather than tone.

The very particular embodiment of FIG. 26 also shows a vibrato arm 2610 and string tensioning structure 2612. A vibrato arm 2610 can differ from a conventional arrangement in that bar position can be detected to generate a tone adjustment value, such as by a potentiometer, or the like. An optional tensioning structure 2612 can allow strings to be tensioned as desired by an instrument player.

FIG. 27 shows a second example of a possible body input section 2700. A body input section 2700 can be like that of FIG. 26, but utilize capacitance sensing to generate sound generation values. A body input section 2700 can thus include one or more body capacitance sensors (one shown as 2730). Input events to body capacitance sensors can be detected according to the approaches described above, or other conventional ways. In the particular example, capacitance sensors can be provided at locations where strings would exist in a conventional stringed instrument. A vibrato arm 2710 can operate in the same fashion as described for FIG. 26.

FIG. 28 shows a third example of a possible body input section 2800. A body input section 2800 can utilize optical sensors to generate sound generation values. A body inputs section 2800 can include one or more light transmitters (one shown as 2802) with corresponding light receivers (one shown as 2804). In the event light transmission is interrupted, a sound generation value can be activated.

FIGS. 29A shows a fourth example of a possible body input section 2900. FIG. 29A is a top plan view showing a body input section 2900 having mechanical switches (one shown as 2930), for sound generation values. FIG. 29B is a side cross sectional view of a switch 2930 showing a possible rotational movement of such a switch. A mechanical switch 2930 can provide discrete state output values (on, off, or a limited number positions), or can provide a ranged value, such as that achievable with a potentiometer or the like.

Of course the particular mechanical switch type illustrated in FIGS. 29A and 29B should not be construed as limiting the invention to any particular switch type.

In this way, inputs at a body section can be utilized to produce sound generation values. Such sound generation values can be utilized to determine, at least in part, when a sound event is started in time, where the quality of the sound event (e.g., tone, pitch) is determined, at least in part, by inputs detected with capacitance sensors in a neck portion.

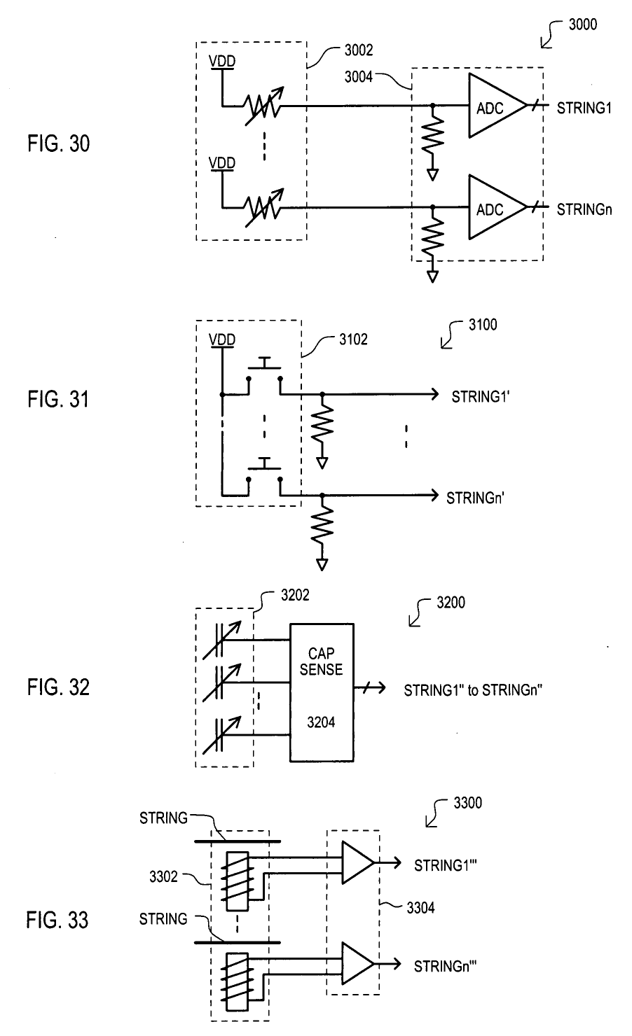

Referring now to FIGS. 30 to 33 various examples of body input sections are shown in a series of block schematic diagrams. FIG. 30 shows a body input section 3000 that includes physical inputs 3002 and a processing section 3004. In the particular example shown, physical inputs 3002 can include resistances that can be varied (e.g., via potentiometer, or the like). In the particular example of FIG. 30, a voltage (or in alternate embodiments a current) generated by such variations can be converted within processing section 3004 into a digital value activation values (STRING1 to STRINGn).

FIG. 31 shows another example of a body input section 3100 that includes physical inputs 3102. Physical inputs 3102 can be mechanical switches. The position of such switches can be used to generate activation values (STRING1′ to STRINGn′).

FIG. 32 shows a third example of a body input section 3200 that includes physical inputs 3202. Physical inputs 3202 can be capacitance sensors. A capacitance of such sensors can be evaluated by a capacitance sense circuit 3204 to generate activation values (STRING1″ to STRINGn″).

FIG. 33 shows a third example of a body input section 3300 that includes physical inputs 3302. Physical inputs 3302 can be electromagnetic transducers, preferably conventional pick-ups. According to conventional techniques values can be amplified by amplifiers 3304 to generate activation values (STRING1′″ to STRINGn′″). Activation values STRING1′″ to STRINGn′″ can be further processed to generate digital activation values or applied to a signal processing circuit, for example.

In this way, a body input section can generate sound activation values.

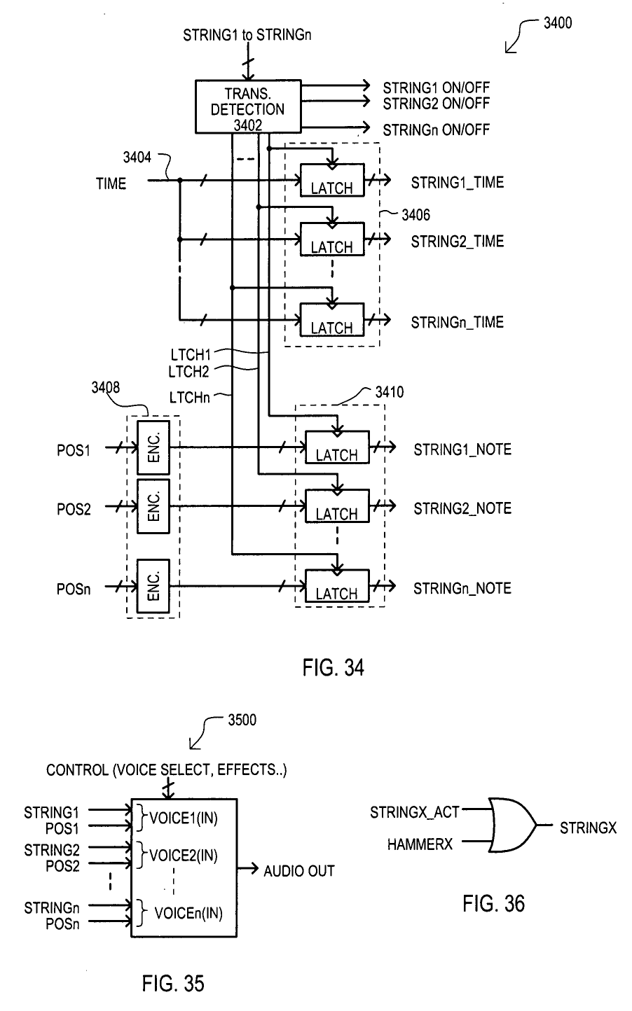

As noted above, sound values generated by capacitance sensors on a neck portion can be combined with sound generation (e.g., activation) values generated by a body input section, or in some cases also generated by sensors in a neck portion. Such various values can be encoded into particular formats for use with digital music production and composition. One particular example of such an arrangement is shown in FIG. 34.

FIG. 34 shows a digital music format encoding circuit 3400 according to one embodiment. An encoding circuit 3400 can include a transition detector 3402, a timer input 3404, one or more time latches 3406, a note encoder section 3408, and one or more note latches 3410. A transition detector 3402 can receive sound activation values STRING1 to STRINGn. When a sound activation value transitions from one state to another, transition detector 3402 can change a corresponding digital on/off value (STRING1_ON/OFF to STRINGn_ON/OFF). In addition, a transition detector 3402 can activate a corresponding latch control signal (LTCH1 to LTCHn). It is noted that a latch control signal (LTCH1 to LTCHn) can be activated according to detected transitions (i.e., activated on on-to-off transitions, as well as off-to-on transitions).

A counter input 3404 can receive a timer value TIME that indicates a time reference value in a digital music system. Time latch(es) 3410 can include a latch corresponding to each sound activation value (STRING1_ON/OFF to STRINGn_ON/OFF). Each such latch can latch timer value TIME in response to its corresponding sound activation value (STRING1_ON/OFF to STRINGn_ON/OFF). Thus, a time value can be latched in response to the activation and deactivation indication.

An encoder section 3408 can receive position values (POS1 to POSn) generated in response to capacitance values derived from sensors in a neck portion. In particular embodiments, position values can be generated according to the above described techniques. An encoder section 3408 can encode position values into digital note values (STRING1_NOTE to STRINGn_NOTE).

Note latch(es) 3408 can include a latch corresponding to each encoded digital note value. In a similar fashion to time latch(es) 3406, each note latch can latch its corresponding digital note value in response to its corresponding sound activation value (STRING1_ON/OFF to STRINGn_ON/OFF). Thus, a note values can be latched in response to the activation and deactivation indication.

In this way, sound activation values and capacitance sensor position values can be encoded into a digital format that includes note numbers, as well as the time at which such notes are turned on or off. Such an arrangement is suitable for encoding input events into predetermined digital music formats, such as the MIDI format.

While an embodiment like that of FIG. 34 can encode sound values and sound activation values into a predetermined digital form, other embodiments can utilize such values for the generation of an analog sound signal. An example of one such approach is shown in FIG. 35.

Referring now to FIG. 35, a sound generation circuit according to one embodiment is shown in a block schematic diagram and designated by the general reference character 3500. A sound generation circuit 3500 can be a polyphonic music synthesizer having multiple voices, each different voice being controlled, at least in part, according a sound activation value (STRING1 to STRINGn) and a corresponding position value (POS1 to POSn). In some embodiments, an encoder section, like that shown as 3408 in FIG. 34, can be included to encode position values into particular formats compatible with a given sound generation circuit. A sound generation circuit 3500 can receive other control input values CONTROL for determining the type of voice generated by activation/position combinations. In embodiments that following the features of a conventional electric guitar, one such CONTROL input can be pitch bending input received from a signal generated by a vibrato arm.

As noted above, a sound activation value can be produced with a body input section like those shown in FIGS. 26 to 33. However, a sound activation value can also be generated by capacitance sensors in a neck portion (e.g., hammer or pull-off). In particular embodiments it may be desirable to generate one activation signal from both such types of signals. Such an arrangement is illustrated by FIG. 36.

FIG. 36 shows how a sound activation value from a body input section (STRINGX_ACT) can be logically combined with one generated from capacitance sensing of a neck portion (HAMMERX) to generate a single sound activation value STRINGX.

In this way, different sound generation signals can be combined to generate a single sound generation value.

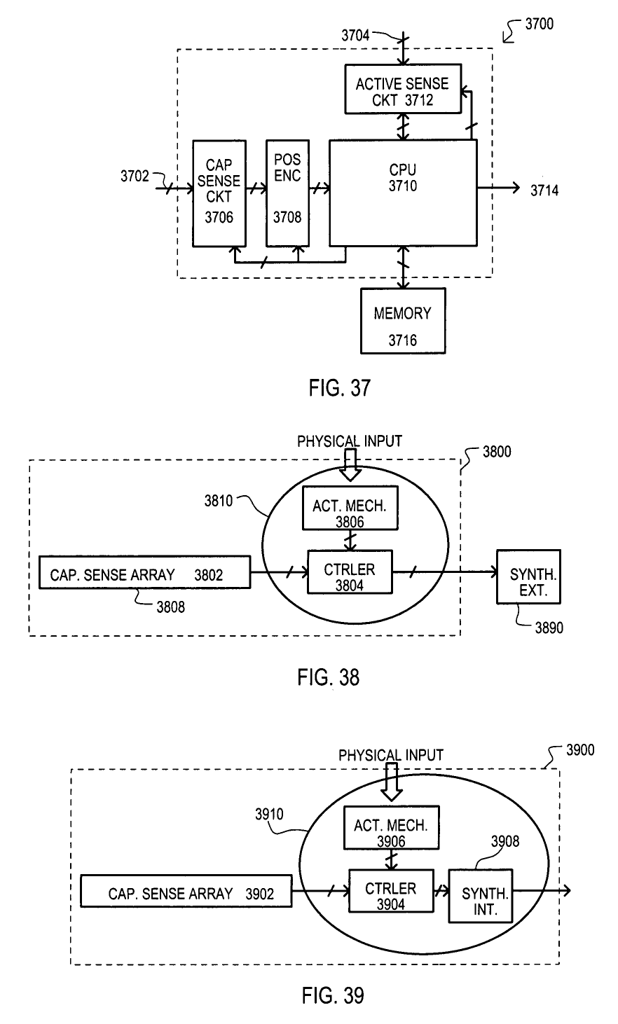

Referring now to FIG. 37, a controller system according to an embodiment is shown in a block schematic diagram and designated by the general reference character 3700. A controller system 3700 can include a number of capacitance sense inputs 3702, one or more activation inputs 3704, a capacitance sense circuit 3706, a position encoder 3708, a central processing unit (CPU) 3710, an activation sense circuit 3712, and a sound value output 3714. Capacitance sense inputs 3702 can be configured to receive inputs from an array of capacitance sensors.

A capacitance sense circuit 3706 can receive capacitance sense input values, and in response thereto, generate sensor activation signals. A capacitance sense circuit 3706 can evaluate capacitance values utilizing including, but not limited to, relaxation oscillator methods and sigma delta modulation methods.

A position encoder 3708 can generate position values from sensor activation signals produced by a capacitance sense circuit 3706. Such position information values can be provided to, or read from, a central processing unit (CPU) 3710.

An activation sense circuit 3712 can detect input events at activation input(s) 3704, and in response, provide activation signals to CPU 3710. CPU 3710 can execute predetermined instructions stored within internal memory, or optionally, in an external memory 3716. According to position values received from position encoder 3708 and activation values received from activation sense circuit 3712, CPU 3710 can generate output values at sound output 3714, as well as provide control signals to the other portions of the controller system 3700.

Preferably, a controller system 3700 can include a PSoC® mixed signal array made by Cypress Semiconductor Corporation of San Jose, Calif., configured to include at least the capacitance sense circuit 3708.

In this way, the embodiments can include a system configured to generate sound values based on capacitance sense inputs and activation inputs different from the capacitance sense inputs.

Various embodiments represented as systems will now be described.

Referring now to FIG. 38, a system according to one embodiment is shown in a block schematic diagram and designated by the general reference character 3800. A system 3800 can include a capacitance sensor array 3802, a controller 3804, and an activation mechanism 3806. A capacitance sensor array 3802 can include a number of capacitance sensors, preferably situated in an array occupying an elongated physical shape. Even more preferably, a capacitance sensor array 3802 can be formed on, or within a neck portion of an instrument having the general shape of a known stringed musical instrument.

An activation mechanism 3806 can detect a physical input to the system to generate activation signals.

A controller 3804 can generate sound values based on sensed capacitance values of capacitance sensor array 3802 and activation signals provided by activation mechanism 3806. In very particular embodiments, a controller 3804 can include any of the circuits and function described above in conjunction with FIGS. 7-9, 11A-12, 14A-15, and 30-37.

The particular system 3800 can be compatible with a sound synthesizer 3890 external to the system 3806. A sound synthesizer 3890 can generate sound waveforms in response to sound values received from controller 3804. In one very particular example, a system 3800 can transmit data in MIDI format, with sound synthesizer being a MIDI compatible instrument.

In one particular arrangement, capacitance sensor array 3808 can be physically situated in a neck portion 3808 of an object having a shape like that of a stringed musical instrument, while the remainder of the system sections can be situated in a body portion 3810 of such an object.

A system according to another embodiment is shown in a block schematic diagram in FIG. 39, and designated by the general reference character 3900. A system 3900 can include the same general sections as that of FIG. 38, thus like sections are referred to by the same reference character but with the first two digits being “39” instead of “38”. System 3900 can differ from that of FIG. 38 in that a sound synthesizer 3908 can be included within the system 3900. Thus, a system 3900 can output an audio signal. As but one example, such a sound signal can be an analog audio signal.

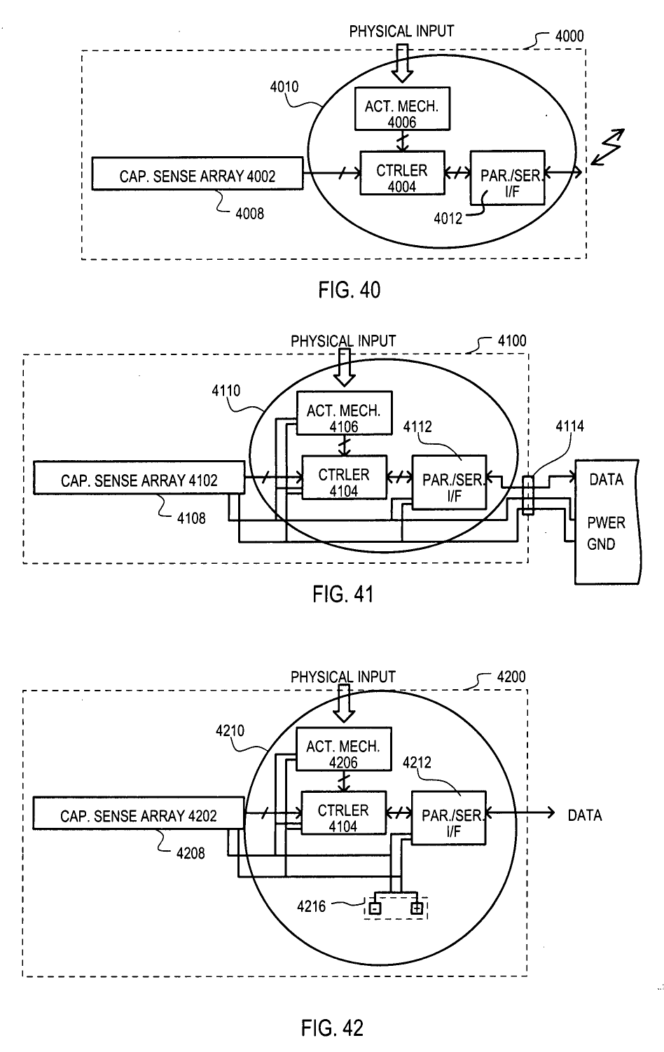

A system according to yet another embodiment is shown in a block schematic diagram in FIG. 40, and designated by the general reference character 4000. A system 4000 can include the same general sections as that of FIG. 38, thus like sections are referred to by the same reference character but with the first two digits being “38” instead of “40”. System 4000 can differ from that of FIG. 38 in that it can include a parallel-to-serial interface 4012.

A parallel-to-serial interface 4012 can receive sound data values from a controller 4004, and convert such values into a serial data stream for transmission on a wire, or in a wireless fashion.

Systems and system components according to the various embodiments described above can form part of a DC powered system that receives power from a conventional AC/DC converter. However, other embodiments can have different power supply arrangements. Two such embodiments are shown in FIGS. 41 and 42.

FIG. 41 shows a system according to an embodiment that is designated by the general reference character 4100. A system 4100 can include the same general sections as that of FIG. 40, thus like sections are referred to by the same reference character but with the first two digits being “40” instead of “41”. System 4100 can differ from that of FIG. 40 in that it can include a connector 4114 suitable for attachment to a cable having both data and power wirings. Thus, a system 4100 can receive power on the cable to which it transmits data. Such an arrangement can enable a system 4100 to be connected various personal computer peripheral interfaces as well as gaming console interfaces. Of course, while FIG. 41 shows an arrangement in which data can be transmitted (and optionally received) in serial format, other embodiments can include parallel data transmission.

An arrangement like that of FIG. 41 may be particularly suitable as a controller device for a PC or gaming console. In such an arrangement, a parallel-to-serial interface 4112 can provide serial data in appropriate format/protocols.

FIG. 42 shows a system according to a further embodiment designated by the general reference character 4200. A system 4200 can include the same general sections as that of FIG. 40, thus like sections are referred to by the same reference character but with the first two digits being “42” instead of “40”. System 4200 can differ from that of FIG. 40 in that it can include a battery connector 4216. A battery connector 4216 can have inputs suitable for connecting to a battery. Optionally, a battery connector 4216 can also have additional inputs suitable for a DC/DC or AD/DC converter. In such an arrangement, a parallel-to-serial interface 4212 is preferably a wireless transmitter/receiver.

While many of the disclosed embodiments have been described in terms of an instrument or object having a neck portion and body portion easily distinguishable from one another, alternate embodiments can include instruments or objects in which a neck portion can extend substantially over, or be integrated with a body portion, or have essentially no body portion. As but a few examples, such alternate shapes can emulate a Chapman Stick, a koto, or a slide guitar, as but a few of the many possible variations.

Embodiments of the present invention are well suited to performing various other steps or variations of the steps recited herein, and in a sequence other than that depicted and/or described herein.

For purposes of clarity, many of the details of the various embodiments and the methods of designing and manufacturing the same that are widely known and are not relevant to the present invention have been omitted from the following description.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

It is also understood that the embodiments of the invention may be practiced in the absence of an element and/or step not specifically disclosed. That is, an inventive feature of the invention can be elimination of an element.

Accordingly, while the various aspects of the particular embodiments set forth herein have been described in detail, the present invention could be subject to various changes, substitutions, and alterations without departing from the spirit and scope of the invention.

What is claimed is:

1. An electronic system for generating music related data based on capacitive sensed inputs, comprising:
a plurality of capacitance sensor inputs for receiving connection to a plurality of capacitance sensors;
at least one activation input for receiving at least one activation signal generated in response to a physical action on the system; and
a control section coupled to the capacitance sensor inputs and the at least one activation input, the control section including at least one processor for sensing the capacitance at selected capacitance sense inputs and generating sense position information therefrom.

2. The electronic system of claim 1, further including:
a plurality of capacitance sensors disposed on at least a first surface of at least one sense member.

3. The electronic system of claim 2, further including:
a plurality of non-conductive strings disposed over the at least first surface.

4. The electronic system of claim 2, wherein:
the at least first surface is divided into a plurality of fret areas adjacent to one another in a first direction, each fret area including at least one capacitance sensor.

5. The electronic system of claim 4, wherein:
the at least first surface includes fret division members that extend upward from the at least first surface and divide the at least first surface into the plurality of fret areas.

6. The electronic system of claim 2, wherein:
the sense member is an elongated member that is longer in a first direction than in a second direction perpendicular to the first direction.

7. The electronic system of claim 2, wherein:
the capacitance sensors are arranged in to an array.

8. The electronic system of claim 2, wherein:
the sense member is formed in a neck portion of a object having the shape of stringed musical instrument; and
the array comprises a plurality of rows, each row corresponding to string locations of the stringed musical instrument.

9. The electronic system of claim 2, wherein:
the sense member has a plurality of tactile indicators disposed essentially parallel to one another in the first direction.

10. The electronic system of claim 2, wherein:
the tactile indicators are selected from the group consisting of: ridges that extend upward from the at least first surface, grooves inset within the at least first surface, discrete features extending upward from the at least first surface, discrete features extending into the at least first surface, variations in roughness, and variations in smoothness.

11. The electronic system of claim 2, further including:
the system is incorporated into an object having the shape of a stringed musical instrument having a neck portion over which strings would be oriented in the stringed musical instrument; and
the at least first surface is formed on the neck portion.

12. The electronic system of claim 11, wherein:
the object further includes a body portion from which the neck portion extends; and
an activation section is formed on the body portion that generates activation information in response to inputs different from the capacitance sense inputs, the activation information being coupled to the at least one activation input.

13. The electronic system of claim 11, wherein:
the object further includes a body portion; and
the neck portion is detachable from the body portion.

14. The electronic system of claim 11, wherein:
the object further includes a body portion; and
the neck portion is attached to the body portion in an articulated fashion.

15. The electronic system of claim 1, further including:
an activation section that generates activation information in response to inputs different from the capacitance sense inputs, the activation information being coupled to the at least one activation input, the activation section comprising a plurality of input strings coupled to at least one transducer that generates a signal that varies in response to vibrations in the input strings.

16. The electronic system of claim 15, wherein:
the system is incorporated into an object having the shape of a stringed musical instrument having a neck portion over which playing strings would be oriented in the stringed musical instrument and a body portion from which the neck portion extends; and
the plurality of input string are disposed over at least a portion of the body and not disposed over the neck portion.

17. The electronic system of claim 2, further including:
an activation section that generates activation information in response to inputs different from the capacitance sense inputs, the activation information being coupled to the at least one activation input, the activation section having at least one element selected from the group consisting of: at least one activation capacitance sensor, at least one optical sensor, at least one mechanical switch, and at least one potentiometer.

18. The electronic system of claim 2, further including:
a plurality of strings formed over the at least first surface, the strings being formed from an essentially nonconductive material.

19. A music data generating instrument having capacitive sense inputs, comprising:
an array of capacitance sensors formed on a neck member that is longer in a first direction than a second direction;
a controller section that receives capacitance values from the capacitance sensors, the controller section including
a sense section that senses the capacitance value of selected capacitance sensors, and
a position encoder that generates position values according to the received capacitance values.

20. The instrument of claim 19, wherein:
the encoded value includes a string portion that identifies a sensed position in the second direction and a fret portion that identifies a sense position in the first direction.

21. The instrument of claim 19, wherein:
the sense section comprises
a plurality of input switches for coupling a plurality of capactive sensors to a common node,
a current supply coupled to the common node, and
a comparator having a first input coupled to the common node.

22. The instrument of claim 21, wherein:
the sense section further includes a counter having an input coupled to the output of the comparator.

23. The instrument of claim 19, further including:
a tone value generator coupled to the position encoder that generates a tone value according to a received position value.

24. The instrument of claim 23, wherein:
the tone value generator comprises a look-up table that stores tone values corresponding to predetermined position values.

25. The instrument of claim 23, further including:
the controller section includes a processor circuit; and
the tone value generator includes machine readable media storing instructions executable by the processor, the instructions including a pitch generator section that generates a pitch value based on adding a base pitch value to an adjustment value that varies according to a position value.

26. The instrument of claim 19, wherein:
the capacitance sensors of the array of capacitance sensors are logically divided into groups of capacitance sensors; and
the position encoder generates one position value for each group of capacitance sensors, each position value being is activated when any capacitance sensor of the corresponding group detects an input event.

27. The instrument of claim 19, wherein:
the logical division of the capacitance sensors is programmable, allowing the capacitance sensors for each group to be altered.

28. The instrument of claim 19, wherein:
the sense section further includes an sound activation detect section that generates a sound activation indication when a capacitance value rate of at least one capacitance sensor is outside of a predetermined limit.

29. The instrument of claim 19, further including:
a sound activation section that generates activation indications in response physical inputs to the instrument; and
a sound synthesizer section coupled to receive the position values and activation indications from the controller section and generate an audio signal therefrom, the audio signal having a starting point based, at least in part, on the activation indications and a tone value generated, at least in part, according to the position values.

30. The instrument of claim 19, further including:
a sound activation section that generates activation indications in response physical inputs to the instrument; and
the controller section further includes an encoding section having
a note on/off encoder that outputs a note on/off indication in response to at least the activation indications, and
a note number encoder that outputs a note number value in response to at least a received position value.

31. The instrument of claim 1 9,further including:
a sound activation section that generates activation indications in response physical inputs to the instrument; and
the controller section further includes a parallel-to-serial converter that generates a serial data output value in response to at least the activation indications and the position values.

32. The instrument of claim 31, wherein:
the parallel-to-serial converter includes a wireless transceiver for transmitting the serial data output values over a wireless connection.

33. The instrument of claim 19, further including:
a physical connector for receiving a wiring external to the musical instrument, the connector having at least one data output and at least one power supply input coupled to at least the controller section.

34. The instrument of claim 19, further including:
a physical connector for having power supply inputs suitable for physical connection with a battery.

35. A method of generating user input data from a controller device, comprising the steps of:
sensing capacitance values at a plurality of sensor inputs coupled to a capacitance sensor array formed on an elongated sense member of the controller device;
in response to predetermined variations in a capacitance of the at least one sensor input, generating position data corresponding to the location of a capacitance sensor corresponding to the variation in capacitance; and
outputting the position data from the controller device.

36. The method of claim 35, wherein:
the position data comprises a serial data value.

37. The method of claim 35, wherein:
the position data comprises digital music data including at least a note number, and a note one time and note off time for the note number.

38. The method of claim 35, wherein:
sensing capacitance values at a plurality of sensor inputs includes scanning the capacitance of sensors in at least two different portions of the capacitance sensor array separately, and in parallel.

39. The method of claim 35, wherein:
sensing capacitance values at a plurality of sensor inputs includes scanning the capacitance of a sub-set of the capacitance sensors of the capacitance sensor array.

40. The method of claim 39, further including:
altering which sub-set of the capacitance sensors is scanned in response to a user input.
